(19) United States
(12) Patent Application Publication
(10) Pub. No.: US 2017/0085155 A1
(43) Pub. Date: Mar. 23, 2017

(54) HIGH EFFICIENCY ENERGY PRODUCTION APPARATUS USING POTENTIAL ENERGY

(71) Applicant: GREEN ELECTRIC TECH, INC., Fairfax, VA (US)

(72) Inventors: Gyu Eob HWANG, Fairfax, VA (US); Si Dae KIM, Daegu (KR)

(21) Appl. No.: 14/951,570

(22) Filed: Nov. 25, 2015

(30) Foreign Application Priority Data
Sep. 21, 2015 (KR) 10-2015-0133453

(51) Int. Cl. H02K 7/18; F03B 17/00; F03G 3/08

(52) U.S. Cl. CPC H02K 7/1853; F03G 3/08; F03B 17/005; Y10S 74/09; F03B 17/04

(57) ABSTRACT

A high efficiency energy production apparatus using potential energy includes a weight body, a circulation chamber allowing the weight body to be moved upwards by buoyancy of liquid, a buoyant chamber extending from an upper surface of the circulation chamber in a vertical direction and accommodating liquid therein, a falling chamber disposed at one side of the buoyant chamber and extending in the vertical direction such that the weight body raised through the buoyant chamber falls freely, a horizontal movement unit moving the weight body from the buoyant chamber to the falling chamber, a power conversion unit converting potential energy of the falling weight body into kinetic energy, a generator generating electricity by receiving the kinetic energy from the power conversion unit, and a control box supplying power for operation of the respective components and controlling the operation.

### CROSS-REFERENCE TO RELATED APPLICATION

This application claims the benefit of Korean Patent Application No. 10-2015-0133453 filed Sep. 21, 2015 in the Korean Intellectual Property Office, the entire disclosure of which is incorporated herein by reference.

### BACKGROUND OF THE INVENTION

1. Field of the Invention

The present disclosure generally relates to a high efficiency energy production apparatus using potential energy, and more particularly (but not exclusively), to a high efficiency energy production apparatus using potential energy, which can lead to generation of electricity using abundant natural resources without complicated and costly equipment.

2. Description of Related Art

Electricity is a necessity in modern society. Most people cannot imagine living a day without electricity because people are so used to enjoying benefits of modern technologies, such as computers, video games, smart TVs, radios, lights, etc. that require electricity. Nowadays, being without electricity for a couple of days or weeks can be a disaster to many people. Sometimes, power outages are characterized as disasters resulting in great financial loss to on-going business concerns and individual homes.

Traditionally, electricity has been produced by natural and/or man-made resources such as coal, water, atomic energy, etc. Many different technologies are available for generating electricity for public use, but they often require large investments and costs in building generation facilities and infrastructure. More often than not, conventional technologies for generating electricity suffer from low efficiency and high loss when generated electricity is delivered to industrial facilities and individual homes for use.

Additionally, various alternative technologies based on abundant natural resources, such as solar power, wind power, seawater, etc. have been proposed and considered, but they have not resulted in widely accepted commercial success because of high investment costs and low efficiency in connection with generating and delivering electricity to end users.

For example, in recent years, solar, wind, seawater based electricity generation plants have been proposed and built in various locations throughout the world. However, they suffer many disadvantages.

For instance, a solar or wind power based facility does not generate and provide enough electricity, as needed by individual homes and industrial plants, because of often unpredictable environmental factors, such as weather and climate conditions. These natural resource based electricity generation facilities cost millions of dollars, even if not billions of dollars, at the beginning of set up and maintenance of the facilities, and often do not deliver purported benefits to customers.

In order to compensate for the shortcomings in that the initial investment cost is very high, small-scale electricity generation apparatuses (small-scale solar energy generation apparatuses, small-scale hydroelectric energy generation apparatuses, small-scale wind power generation apparatuses, etc.) are proposed. However, maintenance costs are still high, which makes it hard to continuously use the small-scale electricity generation apparatuses.

On the other hand, small-scale electricity generation technologies capable of continuously generating electricity using gravity and buoyancy are disclosed in Korean Patent Publication Nos. 10-2009-0097080 and 10-2007-0007729. However, the technologies in these disclosures have a problem in that the structure is complicated and a lot of time and effort are required for maintenance.

Thus, there is a need for more cost effective and energy efficient technologies for generating and delivering electricity to individual homes and industrial facilities alike.

### BRIEF DESCRIPTION OF THE DRAWINGS

The above and other aspects, features and advantages of the present disclosure will become apparent from the following description of exemplary embodiments given in conjunction with the accompanying drawings, in which:

FIG. 1 is a perspective view of a high efficiency energy production apparatus using potential energy according to one embodiment of the present invention;

FIG. 2 is a sectional view of a weight body according to one embodiment of the present invention;

FIG. 3 is a sectional view of the high efficiency energy production apparatus using potential energy according to the embodiment of the present invention;

FIG. 4A is a perspective view of a horizontal movement unit shown in FIG. 3;

FIG. 4B is a plan view of the horizontal movement unit shown in FIG. 4A;

FIG. 5 is a sectional view of a power conversion unit shown in FIG. 3; and

FIG. 6 is a perspective view of first and second gates shown in FIG. 3.

### DETAILED DESCRIPTION

It is an object of the present invention to provide a high efficiency energy production apparatus using potential energy, which can lead to generation of electricity using abundant natural resources without relying on complicated and costly equipment.

It is another object of the present invention to provide a high efficiency energy production apparatus using potential energy, which can be connected to other apparatuses to build small-scale or large-scale electricity generation facilities, regardless of landforms or installation places, etc., thereby remarkably reducing facility investment costs for supply of electricity.

In accordance with one aspect of the present invention, a high efficiency energy production apparatus using potential energy includes: a weight body having a predetermined weight; a circulation chamber allowing the weight body introduced thereinto to be moved upwards by buoyancy of liquid stored therein; a buoyant chamber extending a predetermined length from one side of an upper surface of the circulation chamber in a vertical direction and accommodating liquid therein; a falling chamber disposed at one side of the buoyant chamber and extending a predetermined length in the vertical direction such that the weight body raised through the buoyant chamber falls freely due to the weight thereof; a horizontal movement unit connecting an upper portion of the buoyant chamber and an upper portion of the falling chamber and moving the weight body raised by buoyancy through the buoyant chamber to the falling chamber; a power conversion unit disposed in the falling chamber and converting potential energy of the weight body falling freely due to the weight thereof into kinetic energy; a generator connected to the power conversion unit and generating electricity by receiving the kinetic energy from the power conversion unit; and a control box supplying power for operation of the respective components and controlling the operation.

The circulation chamber may include guide rollers guiding the weight body, which has fallen from the falling chamber, a first gate and a second gate disposed between the guide rollers to prevent change in level of the liquid stored therein while the weight body is being moved from a position below the falling chamber to a position below the buoyant chamber, and a guide tube disposed below the second gate to guide the weight body, which has passed through the first gate, to be moved to the buoyant chamber.

The high efficiency energy production apparatus may further include a water level controller connected to the buoyant chamber or the circulation chamber to maintain the liquid stored in the circulation chamber and the buoyant chamber at a constant level.

The high efficiency energy production apparatus may further include an auxiliary water level adjustment tank disposed above the buoyant chamber to maintain the liquid stored in the buoyant chamber at a constant level.

The weight body may have a predetermined space defined therein so as to be raised by buoyancy, and may contain a weight member in the space near a bottom so as to be maintained in a vertical state in the circulation chamber or in the buoyant chamber.

The horizontal movement unit may include a support plate supporting the weight body raised from the buoyant chamber, a pressurizing device securely gripping the weight body supported by the support plate, and a horizontal feeding device horizontally feeding the weight body gripped by the pressurizing device to the falling chamber.

The support plate may be provided with a pair of fixing arms surrounding the weight body, the fixing arms being pivotally coupled to the support plate by hinges so as to allow the weight body to be moved away therefrom in a horizontal direction.

The pressurizing device may include rotating brackets coupled to shafts in a base block, contact arms, each being disposed at an end portion of each of the rotating brackets and brought into close contact with an outer circumferential surface of the weight body, and a pressurizing cylinder rotating the rotating brackets toward each other or away from each other about the shafts.

The horizontal feeding device may include a base block, to which the pressurizing device is mounted, a horizontal rail extending from the buoyant chamber to the falling chamber, and a horizontal driving cylinder having an end portion connected to the base block and the other end portion connected to a frame in order to move the base block in a horizontal direction.

The power conversion unit may include a vertical rail mounted near the falling chamber in the vertical direction, a support block moved along the vertical rail in the vertical direction, a driving sprocket and a driven sprocket disposed above and below the support block and connected to each other by a chain in order to guide the support block, and a driving motor operating the driving sprocket and the driven sprocket.

The support block may include a driving block moved along the vertical rail by being guided by guide rollers, a support body pivotally connected to the driving block and located in the falling chamber, a first arm and a second arm pivotally disposed below the support body to support the support body, and a collision plate, which is disposed on a top surface of the support body and onto which the falling weight body is seated.

The support block may further include a stopper disposed on a top surface of the driving block to prevent the support body from being folded upwards.

The falling chamber may have an upper protrusion and a lower protrusion arranged apart from each other in a longitudinal direction of the vertical rail to cause the first arm and the second arm to be folded or unfolded while the support body is being moved down or up.

The upper protrusion and the lower protrusion may be slanted toward each other.

The power conversion unit may further include a shock-absorbing member disposed near the driving sprocket to support a driving block which is moved down.

The generator may include a driving motor rotating a flywheel connected to a shaft of a driving sprocket, a clutch connected to the driving motor and permitting or restricting transmission of rotational force from the driving motor to the flywheel, and a generator generating electricity by the flywheel which is continuously rotated at a constant speed by receiving rotational force from the power conversion unit.

Exemplary embodiments will now be described more fully with reference to the accompanying drawings. It will be apparent to those skilled in the art that specific details need not, be employed, that exemplary embodiments may be embodied in many different forms, and that neither should be construed to limit the scope of the disclosure. Exemplary embodiments are provided so that this disclosure will be thorough and will fully convey the scope to those skilled in the art. In the drawings, the sizes of components may be exaggerated for clarity.

Although the terms first, second, third, etc. may be used herein to describe various elements, components, regions, layers and/or sections, these elements, components, regions, layers and/or sections should not be limited by these terms. These terms may only be used to distinguish one element, component, region, layer or section from another element, component, region, layer or section.

The terminology used herein is for the purpose of describing particular example embodiments only and is not intended to be limiting. As used herein, the singular forms “a,” “an,” and “the” may encompass the plural forms as well, unless context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof.

In physics, potential energy is the energy of an object due to a position of the object (i.e. raised to a height from a ground level). Potential energy is often associated with restoring forces, such as the force of gravity. Gravity is generally described as force pulling all matter.

Gravity exerts a constant downward force on the center of mass of an object moving near the surface of the earth. The action of lifting an object having mass from an initial position is performed by an external force that works against a force field of the potential.

In addition, work is stored in the force field, which is often said to be stored as potential energy. If the external force is removed, the force field acts on the object to perform the work as it moves the object back to the initial position (i.e., a ground level), causing the object to fall. The potential energy due to an elevated position is called gravitational potential energy.

According to laws of physics, an amount of potential energy required to raise an object having mass to a height from the surface of the earth is equal to the product of the mass of the object times the acceleration due to gravity times the height. That is, an amount of the potential energy at an elevated position is directly proportional to the height of the elevated position. Further, when an object is submerged in a liquid, it rises to a surface of the liquid if a weight of the object is less than a weight of a volume of the liquid displaced by the object, that is, when the object is buoyant.

The present invention utilizes these natural laws and principles, such as potential energy. That is, one or more buoyant weights can be raised to a certain height, building and storing a significant amount of gravitational potential energy of the one or more weights in the raised position. When the one or more weights raised to the certain height are allowed to fall, the one or more weights convert the stored gravitational potential energy into kinetic energy as the one or more weights reach the ground.

A significant advantage of the present invention is repeated use of raising one or more weight bodies using buoyancy and allowing the same to fall and accelerate due to gravity, thereby converting the stored gravitational potential energy into kinetic energy, which is in turn converted into electricity.

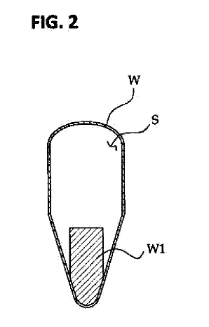

Referring to FIG. 2, a weight body W is formed to have a shape with a predetermined size, which is pointed at the bottom thereof and has a space S formed therein and a weight member W1 having a predetermined weight and disposed in the space near the bottom, such that the weight body W is always directed downward due to the weight of the weight member W1 in a buoyant chamber or a circulation chamber, which will be described below. The weight body W can be raised by buoyancy in the circulation chamber and the buoyant chamber in a state in which the bottom, near which the weight member is disposed, is directed downward, and the top, in which the empty space is formed, is directed upward.

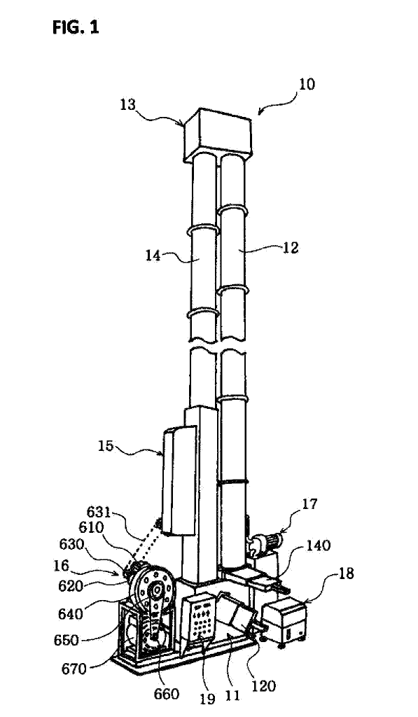

Referring to FIG. 1, a high efficiency energy production apparatus 10 using potential energy according to one embodiment of the invention includes a circulation chamber 11, a buoyant chamber 12, a horizontal movement unit 13, a falling chamber 14, a power conversion unit 15, a generator 16, a water level controller 17, a hydraulic pressure controller 18, and a control box 19.

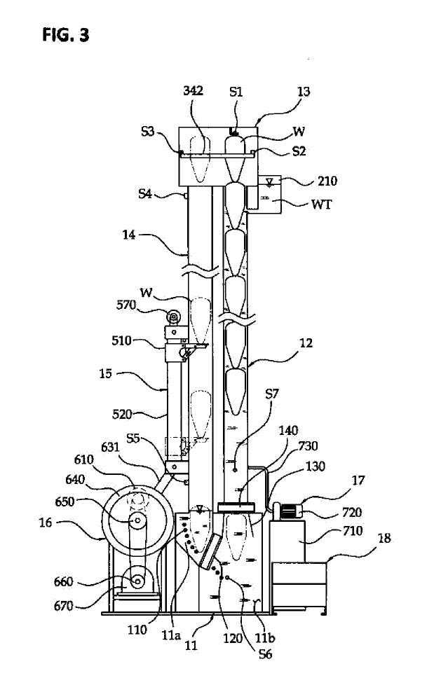

Referring to FIG. 3, the circulation chamber 11 is disposed at a lower portion of the energy production apparatus and is divided into a first space 11a and a second space 11b.

The circulation chamber 11 includes guide rollers 110, which are arranged in the first space 11a and the second space 11b in order to guide the weight body failing to the first space 11a from the falling chamber 14 to move to the second space 11b, a first gate 120, which is disposed between the guide rollers 110 and is opened or closed to prevent liquid in the second space 11b from excessively flowing to the first space 11a, a guide tube 130, which guides the weight body W located in the second space 11b to move toward the buoyant chamber 12, and a second gate 140, which is disposed between the buoyant chamber 12 and the circulation chamber 11 and is opened and closed to prevent the water level in the buoyant chamber from being lowered and to allow the weight body located in the second space 11b to move to the buoyant chamber.

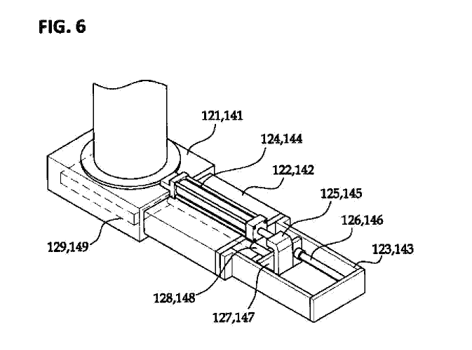

Referring to FIG. 6, each of the first gate 120 and the second gate 140 includes a gate body 121, 141, an extending gate 122, 142 extending from one side of the gate body 121, 141 to secure a space in which a gate is moved, a rail support frame 123, 143 coupled to one side of the extending gate 122, 142, a rail bracket 127, 147 moved along a rail 126, 146 disposed in the rail support frame 123, 143 in a longitudinal direction, a connecting bracket 125, 145 secured to the rail bracket 127, 147, a driving cylinder 124, 144 having one end supported by the gate body 121, 141 and the other end supported by the connecting bracket 125, 145 to allow a gate 129, 149 to slide, and an operating bar 128, 148 having one end secured to the rail bracket 127 and 147 and the other end connected to the gate 129 and 149 to drive the gate 129 and 149 depending on the operation of the driving cylinder.

The buoyant chamber 12 has a tube shape having a predetermined length and is disposed on the circulation chamber 11, in which the weight body is raised upward by buoyancy of the liquid WT stored therein. An auxiliary water level adjustment tank 210 is disposed above the buoyant chamber so as to maintain the liquid in the buoyant chamber at a constant level. Additionally, a water level controller 17 is disposed below the buoyant chamber to supply liquid to the buoyant chamber so as to maintain a constant water level in the buoyant chamber.

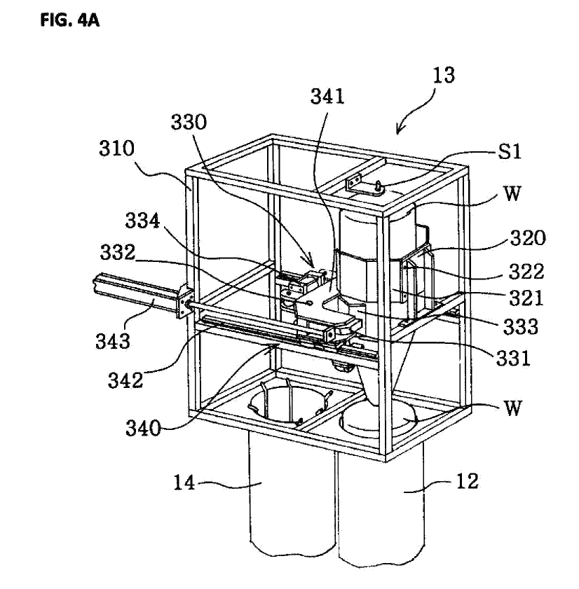

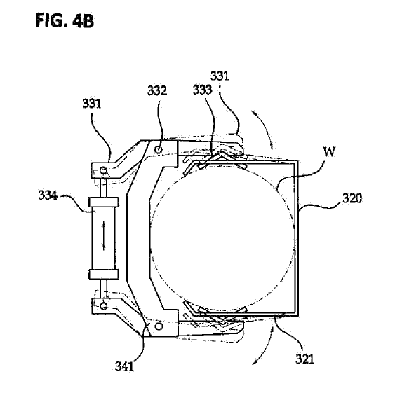

Referring to FIGS. 4A and 4B, the horizontal movement unit 13 includes a frame 310, a support plate 320, a pressurizing device 330, and a horizontal feeding device 340.

The frame 310 is a structure for connecting the buoyant chamber 12 and the falling chamber 14, in which the support plate, the pressurizing device and the horizontal driving device are mounted.

The support plate 320 has a U-shaped cross-section and extends in the vertical direction. A pair of fixing arms 321 is provided so as to be pivoted to a predetermined extent by the support plate and hinges 322.

Herein, the hinges 322 have an elastic member (not shown), which is hingedly disposed to pressurize the fixing arms toward each other, thereby enabling the fixing arms to grip the weight body located between the support plate and the fixing arms.

The support plate and the fixing arms have a bottom surface, which is expanded outwards so that the weight body can be smoothly introduced into the space between the support plate and the fixing arms.

The pressurizing device 330 includes a pair of rotating brackets 331 rotated about shafts 332, contact arms 333, each being disposed at an end portion of each of the rotating brackets 331 and brought into close contact with the weight body depending on the operation of the rotating brackets 331, and a pressurizing cylinder 334 rotating the rotating brackets 331 toward each other about the shafts.

Although it is illustrated in the drawings that the contact arms 333 have an angular shape, the contact arms 333 may be formed to have a weight body-contact surface, which is curved corresponding to the outer circumferential surface of the weight body and has a predetermined elasticity.

The horizontal feeding device 340 includes a horizontal rail 342 arranged to connect the buoyant chamber 12 and the falling chamber 14, a base block 341 which is moved along the horizontal rail 342 and to which the pressurizing device 330 is mounted, and a horizontal driving cylinder 343 having an end portion connected to the base block 341 and the other end portion connected to the frame 310 in order to move the base block 341 along the horizontal rail 342.

The falling chamber 14 has the same length as the buoyant chamber 12 and is mounted vertically, as shown in FIG. 3. The falling chamber 14 has a space defined therein, in which the weight body falls, and does not accommodate liquid therein.

The power conversion unit 15 includes a vertical rail 520 mounted near the side surface of the falling chamber 14 in the vertical direction with a predetermined length, a support block 510 lifted up and down along the vertical rail 520, a driving sprocket 530 and an auxiliary sprocket 531 disposed below the vertical rail 520 and connected to the generator 16 using a chain, a driven sprocket 540 and an auxiliary sprocket 541 disposed above the vertical rail 520, a chain 550 connected to the top surface and the bottom surface of the support block via the driving sprocket 530, the auxiliary sprocket 531, the driven sprocket 540 and the auxiliary sprocket 541, and a driving motor 570 connected to the driven sprocket 540 to apply rotational force to the driven sprocket 540 and having a brake (not shown) mounted to a shaft thereof to stop the operation of the shaft depending on a signal from the control box.

Herein, the brake is used to keep the support block, which is lifted up and down by the driving motor, in a stationary state when it is located at an upper position. When the weight body is sensed by a sensor, which will be described below, the brake is released, and thus the support block can be lowered.

The support block 510 includes a driving block 511 lifted up and down along the vertical rail 520 by a plurality of guide rollers 512 rolling on the vertical rail 520, a support body 513 extending horizontally from the top surface of the driving block 511 and pivotally coupled to a shaft 517, a collision plate 514 which is disposed on the top surface of the support body 513 and onto which the falling weight body is seated, a first arm 515 pivotally disposed below the support body 513, a second arm 516 having an end portion pivotally connected to the first arm 515 and the other end portion pivotally connected to the bottom surface of the support body 513, and fixing brackets 518 which are disposed on the top surface and the bottom surface of the driving block 511 and to which the chain 550 is secured.

A stopper 511a is disposed on the top surface of the driving block 511 in order to keep the support body 513 in a horizontal state and prevent the support body 513 from being folded upwards.

The falling chamber 14 has an upper protrusion 410 and, a lower protrusion 420, which are arranged between the falling chamber 14 and the vertical rail 520. A shock-absorbing member 560 is disposed at a lower portion of the vertical rail 520 in order to limit descending movement of the driving block and provide stable shock-absorption. The shock-absorbing member 560 is preferably embodied as a shock absorber cylinder, but may also be embodied as any type of shock-absorber having suitable shock-absorbing performance.

Referring again to FIG. 1, the generator 16 includes a driving motor 610, a clutch 620, a driving sprocket 630, a flywheel 640, a driving pulley 650, a driven pulley 660, and a generator 670. The generator 16 is interlocked with the power conversion unit 15 by a chain 631, and is interlocked with the generator by a belt pulley.

The driving motor 610 is operated by external power supplied thereto and rotates the flywheel at a predetermined RPM in an initial stage.

The clutch 620 is connected to the driving motor 610, and functions to permit or restrict the transmission of rotational force from the driving motor to the flywheel depending on a signal from the control box. When the RPM of the flywheel reaches a predetermined RPM in an initial stage, the clutch releases the driving connection between the driving motor and the flywheel.

However, in some cases, when the RPM of the flywheel is suddenly decreased, the clutch can restore the driving connection with the driving motor to rotate the flywheel. To this end, the flywheel is provided with an element (not shown) for measuring the RPM of the flywheel, which is electrically connected to the control box.

Referring again to FIG. 3, the water level controller 17 allows water, stored in a water storage tank 710, to be supplied to the buoyant chamber 12 through a water supply line 730 connected to the buoyant chamber 12 using a pump 720. When a water level sensor (not shown) disposed at an upper portion of the buoyant chamber 12 senses that the water level in the buoyant chamber is below a predetermined point, the water level controller 17 is operated.

The hydraulic pressure controller 18 supplies hydraulic pressure or pneumatic pressure to the cylinders used in the circulation chamber 11 and the horizontal movement unit 13 in order to control the cylinders.

Since the hydraulic pressure controller 18 has a typical structure for performing the hydraulic pressure or pneumatic pressure supply operation and the control operation, detailed explanation thereof will be omitted.

The control box 19 controls sensors used in the aforementioned components (the circulation chamber, the buoyant chamber, the horizontal movement unit, the falling chamber, the power conversion unit, the generator, etc.) and to control operation of the components.

The aforementioned components (the circulation chamber, the buoyant chamber, the horizontal movement unit, the falling chamber, the power conversion unit, the generator, etc.) are operated using electricity supplied from the outside. The components may be operated using electric power supplied from an external electricity generation facility, or may be connected to an electricity generation system using natural energy, such as water power, wind power, etc., in order to receive electricity necessary for operation.

Hereinafter, operation of the present invention will be explained with reference to the attached drawings.

First, as shown in FIG. 3, a plurality of weight bodies W is sequentially stacked in the buoyant chamber 12, and the weight body W, which is located at the uppermost position, is located in the horizontal movement unit 13 by buoyancy.

At this time, the weight body W in the horizontal movement unit 13 is located between the support plate 320 and the fixing arms 321. In this state, when a sensor S1 provided in the horizontal movement unit 13 senses the weight body W, as shown in FIG. 4A, the pressurizing cylinder 334 is operated based on a signal from the control box 19 so that the pair of rotating brackets 331, which have been moved away from the outer circumferential surface of the weight body, are rotated toward each other about the shafts 332, thereby securely gripping the weight body.

Although not shown in the drawings, the sensor S1 is preferably provided with a stopper (not shown) for absorbing shock, which is generated in the ascending movement of the weight body, and stably supporting the weight body located between the sensor and another weight body located therebelow.

Then, the horizontal feeding device 340 is operated so as to feed the weight body W gripped by the pressurizing device 330 from the position above the buoyant chamber 12 to the position above the falling chamber 14.

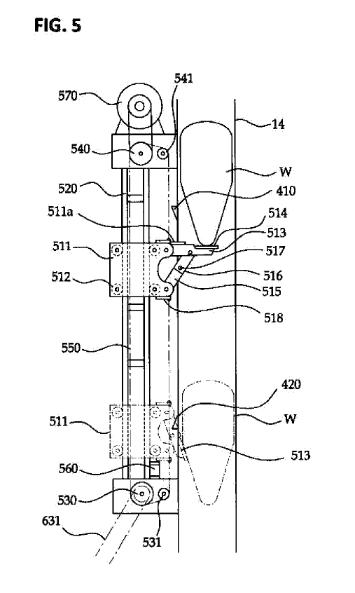

The weight body fed toward the falling chamber moves away from a sensor S2 mounted to the horizontal feeding device above the buoyant chamber, and is sensed by a sensor S3 mounted above the falling chamber, thereby checking that the weight body is located above the falling chamber. After the position of the weight body is checked, the pressurizing device 330 releases the weight body W based on a signal from the control box 19, and the weight body W falls freely due to gravity in the falling chamber 15. As shown in FIGS. 3 and 5, the falling weight body is seated on the support body 513 of the power conversion unit 15, which is provided at a portion of the falling chamber.

The falling weight body is sensed by a sensor S4 which is mounted to an upper portion of the falling chamber 14, thereby checking that the weight body is falling. At the same time, the brake mounted to the driving motor of the power conversion unit is released to permit operation of the shaft, and thus the support block descends slowly due to gravity. The falling weight body is seated on the support block while the support block is descending. As the driving block 511 descends along the vertical rail 520 by the falling speed and the weight of the weight body, the driving block 511 operates the chain 550, thereby rotating the driving sprocket 530.

At this time, the flywheel 640 is in a state of being disconnected from the driving motor 610 by the clutch because the flywheel 640 has started to be rotated at a predetermined RPM by the driving motor 610 before the weight body W falls.

Since the generator 16, which is connected to the rotating driving sprocket 530 by the chain 631, has already operated the clutch 620 to perform disconnection from the driving motor, only the driving sprocket 630 of the generator 16 is rotated, and applies rotational force to the flywheel, which is in a state of being rotated, thereby maintaining the RPM of the flywheel.

In other words, kinetic energy (rotational force) transmitted from the power conversion unit is added to the flywheel, which is in a state of being rotated, thereby maintaining the rotation of the flywheel. Such continuous rotation of the flywheel can lead to efficient electricity generation.

In one example, when the RPM of the flywheel is increased to a predetermined extent (e.g. 500 to 520 RPM), at which the generator can generate electricity, by the driving motor 610 in an initial stage and an RPM sensor senses that the RPM of the flywheel reaches a target RPM, the clutch 620 is controlled to be separated from the flywheel by the control box based on the sensed RPM, the weight body located in the falling chamber falls, the driving block of the power conversion unit descends, the driving sprocket connected to the driving block is rotated, and thus the RPM of the flywheel is maintained. Based on this series of operating processes, when the weight body is controlled to fall repeatedly, the descending movement of the driving block of the power conversion unit is consecutively and continuously carried out, thereby maintaining the RPM of the flywheel.

As shown in FIG. 5, when the weight body completely descends to the lower portion of the power conversion unit 15, the first arm 515 and the second arm 516, which support the driving block 511 and the support body 513, are pushed by the lower protrusion 420 formed at the lower portion of the falling chamber and are folded toward the driving block, and the support body 513, which has been maintained in a horizontal state, is also folded downwards. As a result, the weight body, which has been placed on the support body, falls due to gravity.

If the falling weight body is sensed by a sensor S5, which is located below the power conversion unit, and it is checked that the weight body is moved away from the power conversion unit, the driving motor 570 is operated depending on a signal from the control box, so as to lift up the driving block 511, which stays at the lower portion of the power conversion unit, along the vertical rail 520.

The ascending driving block 511 reaches the upper protrusion 410 formed at the upper portion of the falling chamber. At this time, the first arm 515 and the second arm 516, which have been in a state of being folded, are pushed by the upper protrusion 410, and are unfolded. Accordingly, the support body connected to the second arm is turned to a horizontal state.

The stopper 511a, which is disposed on the top surface of the driving block, functions to keep the support body in a horizontal state and prevent the support body from being moved from the horizontal state. The support body, which is maintained in a horizontal state, waits for falling of the next weight body.

If the falling weight body W is sensed by the sensor S5, the first gate 120 is opened so that the weight body W, which has fallen to the first space 11a of the circulation chamber 11, can be guided by the guide rollers 110 and smoothly moved to the second space 11b through the first gate 120 by the falling speed thereof. If the weight body W moved to the second space 11b is sensed by a sensor S6, a signal for closing the first gate 120 is generated.

The second gate 140 is opened simultaneously with generation of the signal for closing the first gate 120. Therefore, the weight body W located in the second space 11b is raised by buoyancy and guided by the guide tube 130 disposed in the second space, passes through the opened second gate 140, and enters the buoyant chamber 12.

A sensor S7 is disposed at the lower portion of the buoyant chamber. If the sensor S7 senses that the weight body W has entered the buoyant chamber, the opened second gate is controlled to be closed.

A plurality of weight bodies located in the buoyant chamber pushes the uppermost weight body up to the horizontal movement unit due to buoyancy. The uppermost weight body located in the horizontal movement unit gets ready to be moved to the falling chamber. Simultaneously with the movement of the uppermost weight body to the falling chamber, the next weight body is sequentially raised up to the horizontal movement unit and gets ready to be moved to the falling chamber. By way of this process, if a plurality of weight bodies consecutively falls in the falling chamber, the power conversion unit is operated, and the flywheel, which is connected to the power conversion unit and is already being rotated at a predetermined RPM, can be continuously rotated. As a result, electricity can be generated.

Through the consecutive and repeated performance of the aforementioned process, the generator can be operated, which achieves small-scale electricity generation. Accordingly, electric power generated from the generator can be used in homes or the like. Further, if the energy production apparatus according to the present invention is installed in groups, a systemized small-scale electricity generation facility can be constructed, thereby supplying electricity to small-scale industrial sites or the like.

As is apparent from the above description, the high efficiency energy production apparatus using potential energy according to the present invention can generate electricity using abundant natural resources without complicated and costly equipment.

Further, the high efficiency energy production apparatus according to the present invention can be connected to other apparatuses to build small-scale or large-scale electricity generation facilities, regardless of landforms or installation places, etc., thereby remarkably reducing facility investment costs incurred by supply of generated electricity.

The foregoing description of the embodiments has been provided for purposes of illustration and description. It is not intended to be exhaustive or to limit the disclosure.

That is, it should be understood by those skilled in the art that these embodiments are given by way of illustration only, and that various modifications, variations, and alterations can be made without departing from the spirit and scope of the present disclosure. Such variations are not to be regarded as a departure from the disclosure, and all such modifications are intended to be within the scope of the disclosure.

What is claimed is:

1. A high efficiency energy production apparatus using potential energy, comprising:
a weight body having a predetermined weight;
a circulation chamber allowing the weight body introduced thereinto to be moved upwards by buoyancy of liquid stored therein;
a buoyant chamber extending a predetermined length from one side of an upper surface of the circulation chamber in a vertical direction and accommodating liquid therein;
a falling chamber disposed at one side of the buoyant chamber and extending a predetermined length in the vertical direction such that the weight body raised through the buoyant chamber falls freely due to gravity;
a horizontal movement unit connecting an upper portion of the buoyant chamber and an upper portion of the falling chamber and moving the weight body raised by buoyancy through the buoyant chamber to the falling chamber;
a power conversion unit disposed in the falling chamber and converting potential energy of the weight body falling freely due to gravity into kinetic energy;
a generator connected to the power conversion unit and generating electricity by receiving the kinetic energy from the power conversion unit; and
a control box supplying power for operation of the respective components and controlling the operation.

2. The high efficiency energy production apparatus according to claim 1, wherein the circulation chamber includes guide rollers guiding the weight body, which has fallen from the falling chamber, a first gate and a second gate disposed between the guide rollers to prevent change in level of the liquid stored therein while the weight body is being moved from a position below the falling chamber to a position below the buoyant chamber, and a guide tube disposed below the second gate to guide the weight body, which has passed through the first gate, to be moved to the buoyant chamber.

3. The high efficiency energy production apparatus according to claim 2, further comprising:
a water level controller connected to the buoyant chamber or the circulation chamber to maintain the liquid stored in the circulation chamber and the buoyant chamber at a constant level.

4. The high efficiency energy production apparatus according to claim 3, further comprising:
an auxiliary water level adjustment tank disposed above the buoyant chamber to maintain the liquid stored in the buoyant chamber at a constant level.

5. The high efficiency energy production apparatus according to claim 1, wherein the weight body has a predetermined space defined therein so as to be raised by buoyancy, and contains a weight member in the space near a bottom so as to be maintained in a vertical state in the circulation chamber or in the buoyant chamber.

6. The high efficiency energy production apparatus according to claim 1, wherein the horizontal movement unit includes a support plate supporting the weight body raised from the buoyant chamber, a pressurizing device securely gripping the weight body supported by the support plate, and a horizontal feeding device horizontally feeding the weight body gripped by the pressurizing device to the falling chamber.

7. The high efficiency energy production apparatus according to claim 6, wherein the support plate is provided with a pair of fixing arms surrounding the weight body, the fixing arms being pivotally coupled to the support plate by hinges so as to allow the weight body to be moved away therefrom in a horizontal direction.

8. The high efficiency energy production apparatus according to claim 6, wherein the pressurizing device includes rotating brackets coupled to shafts in a base block, contact arms, each being disposed at, an end portion of each of the rotating brackets and brought into close contact with an outer circumferential surface of the weight body, and a pressurizing cylinder rotating the rotating brackets toward each other or away from each other about the shafts.

9. The high efficiency energy production apparatus according to claim 6, wherein the horizontal feeding device includes a base block, to which the pressurizing device is mounted, a horizontal rail extending from the buoyant chamber to the falling chamber, and a horizontal driving cylinder having an end portion connected to the base block and the other end portion connected to a frame in order to move the base block in a horizontal direction.

10. The high efficiency energy production apparatus according to claim 1, wherein the power conversion unit includes a vertical rail mounted near the falling chamber in the vertical direction, a support block moved along the vertical rail in the vertical direction, a driving sprocket and a driven sprocket disposed above and below the support block and connected to each other by a chain in order to guide the support block, and a driving motor operating the driving sprocket and the driven sprocket.

11. The high efficiency energy production apparatus according to claim 10, wherein the support block includes a driving block moved along the vertical rail by being guided by guide rollers, a support body pivotally connected to the driving block and located in the falling chamber, a first arm and a second arm pivotally disposed below the support body to support the support body, and a collision plate, which is disposed on a top surface of the support body and onto which the falling weight body is seated.

12. The high efficiency energy production apparatus according to claim 11, wherein the support block further includes a stopper disposed on a top surface of the driving block to prevent the support body from being folded upwards.

13. The high efficiency energy production apparatus according to claim 11, wherein the falling chamber has an upper protrusion and a lower protrusion arranged apart from each other in a longitudinal direction of the vertical rail to cause the first arm and the second arm to be folded or unfolded while the support body is being moved down or up.

14. The high efficiency energy production apparatus according to claim 13, wherein the upper protrusion and the lower protrusion are slanted toward each other.

15. The high efficiency energy production apparatus according to claim 10, wherein the power conversion unit further includes a shock-absorbing member disposed near the driving sprocket to support a driving block which is moved down.

16. The high efficiency energy production apparatus according to claim 10, wherein the generator includes a driving motor rotating a flywheel connected to a shaft of a driving sprocket, a clutch connected to the driving motor and permitting or restricting transmission of rotational force from the driving motor to the flywheel, and a generator generating electricity by the flywheel which is continuously rotated at a constant speed by receiving rotational force from the power conversion unit.
